(19) United States
(12) Patent Application Publication
(10) Pub. No.: US 2011/0094108 A1
(43) Pub. Date: Apr. 28, 2011

(54) Shaving Cartridge Cap Having Flow Channels

(76) Inventor: Kevin James Wain, Reading (GB)

(21) Appl. No.: 12/603,643

(22) Filed: Oct. 22, 2009

(51) Int. Cl. B26B 21/14

(52) U.S. Cl. 30/77; 30/84

(57) ABSTRACT

A razor cartridge is provided having a first lateral end portion, a second lateral end portion, a front portion and a rear portion, wherein the rear portion has a back end wall. At least one blade is mounted to the housing, wherein the blade has a length extending from the first lateral end portion to the second lateral end portion. A guard is positioned at the front of the housing, and extends from the first lateral end portion to the second lateral end portion. A cap is positioned at the rear portion of the housing and has a length extending from the first lateral end portion to the second lateral end portion. The cap has a plurality of ribs generally transverse to the blade which define a plurality of channels that extend from the rear portion of the housing to at least along a portion of the rear wall.

### FIELD OF THE INVENTION

The present invention relates to shaving razors and more particularly to shaving razor cartridges having a housing with a cap that provides improved comfort without the need of a shaving aid strip.

### BACKGROUND OF THE INVENTION

In recent years shaving razors with numerous blades have been proposed in the literature and commercialized, e.g., in U.S. Pat. Pub. 2005/0039337 A1 published on Feb. 24, 2005, which generally describes a type of design that has been commercialized globally as the five bladed Fusion™ razor by The Gillette Company.

In emerging markets, such as China and India, the shaving razor of choice is a standard double edge style razor, e.g., in U.S. Pat. No. 3,274,683 issued Sep. 27, 1966, generally describes a typical design used in emerging markets. Consumers in these markets typically do not have the means to purchase the shaving razors that are widely popular in the United States. The standard double edge style razor may be economical, but the user tends to experience nicks, cuts and irritation.

Shaving consumers in emerging markets typically shave infrequently, sometimes only once or twice a week. There is also little or no availability of running water to rinse or clean a shaving razor and the availability of skin cleansers and pre-shaving and post-shaving shaving aids are limited. Pre-shaving aids may include shaving oils, gels and lotions and post-shaving aids may include after shave gels, lotions and moisturizers. A cup or bowl is typically filled with water and is used to rinse the shaving razor. The shaving razors disclosed in the above mentioned patent application are quite sophisticated having have been designed for Western shaving habits, practices and environments, and thus do not deliver an ideal shaving experience for consumers in emerging markets. The shaving consumer in emerging countries have a much different shaving environment as well as different shaving habits and practices than the typical shaving consumer in more developed countries, such as the United States. Even if a less sophisticated version of the popular five bladed Fusion™ shaving razor was available for these consumers, it would still not provide the optimal shaving experience because of their unique shaving environment, habits, practices and shaving environment.

### SUMMARY OF THE INVENTION

In one aspect, the invention features, in general, a shaving razor including a first lateral end portion, a second lateral end portion, a front portion and a rear portion, wherein the rear portion has a back end wall. At least one blade is mounted to the housing, wherein the blade has a length extending from the first lateral end portion to the second lateral end portion. A guard is positioned at the front of the housing, and extends from the first lateral end portion to the second lateral end portion. A cap is positioned at the rear portion of the housing and has a length extending from the first lateral end portion to the second lateral end portion. The cap has a plurality of ribs generally transverse to the blade which define a plurality of channels that extend from the rear portion of the housing to at least along a portion of the rear wall.

### BRIEF DESCRIPTION OF THE DRAWINGS

FIG. 1 is a top perspective view of one possible embodiment of a shaving cartridge.

FIG. 2 is a rear view of the cartridge of FIG. 1

FIG. 3 is an enlarged top plan view of the cartridge shown in FIG. 1.

FIG. 4 is a top perspective view of another possible embodiment of a shaving cartridge.

### DETAILED DESCRIPTION OF THE INVENTION

The invention is not limited to shaving cartridges in which the blades are rigidly mounted in a fixed position relative to the guard and/or cap. If the blades are capable of movement then the geometric parameters stipulated herein are those which apply when the blades are in their normal rest positions.

Each of the illustrated safety razor blade units are intended to be mounted on a razor handle. The blade unit may be permanently attached to the handle, e.g., in a disposable razor, or may be formed as a cartridge adapted to be mounted releasably to the handle. The blade unit may be pivotally mounted to the handle or may be fixedly attached to the handle.

One or more cutting blades may be mounted to a housing. The term “mounted to” may be defined as any of the following disclosed herein. The cutting blades blade may be supported firmly by the housing to remain substantially fixed in the positions in which they are depicted (subject to any resilient deformation which the blades undergo under the forces applied against the blades during shaving). Alternatively, the blades may be supported for limited movement against spring restoring forces, e.g., in a downward direction as viewed in the drawings. The basic construction and assembly of the blade units may be conventional.

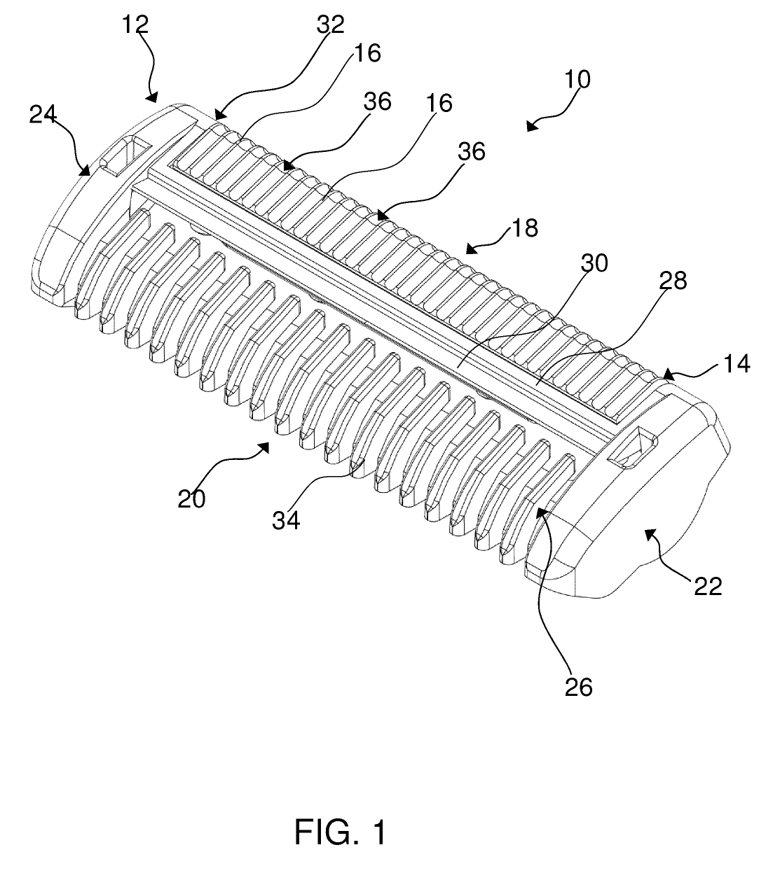

Referring to FIG. 1, one possible embodiment of the present disclosure is shown illustrating a shaving cartridge 10. The shaving cartridge 10 may include a housing 12 having a rear portion 18, a front portion 20, a first lateral end portion 22, and a second lateral end portion 24. The front portion 20 may include a guard 26 that extends longitudinally from the first lateral end portion 22 to the second lateral end portion 24. A cap 14 may be positioned at the rear portion 18 of the housing 12 and may extend from the first lateral end portion 22 to the second lateral end portion 24. A blade 30 for cutting hairs may be mounted to the housing 12 between the cap 14 and the guard 26. The blade 30 may extend from the first lateral end portion 22 to the second lateral end portion 24, generally parallel to the guard 26 and the cap 14. Although only a single blade 30 is shown multiple blades 30 may be mounted to the housing 12.

The guard 26 may include a plurality of projections 34 that are positioned along a substantial length of the guard 26 and extend up to or distally beyond the housing 12 to act as comb feature to receive and/or align hairs during shaving. The projections 34 may have a length and may extend generally traverse to the blade 30. In certain embodiments the length may be about 3 mm, 5 mm or 8 mm to about 9 mm, 10 mm or 11 mm. The guard 26 may have about 8, 12, 16 to about 18, 20 or 25 projections 34 along its length that are uniformly spaced apart from each other. The guard 26 and the projections 34 may be configured for the management of skin and may aid in guiding hair to the blade 30. The guard 26 may be integral with the housing and molded from polymers such as high impact polystyrene (HIPS), but other semi-rigid polymers such as polypropylene (PP) and acrylonitrile butadiene styrene (ABS) may also be used. The guard 26 and projections 34 may be molded from the same or a different polymer than the housing 12.

Usually shaving cartridges include a shaving aid, such as a lubricating strip joined to the cap or the cap may include a shaving aid composite to deliver a lubricious substance to the user's skin, e.g., as described in U.S. Pat. Nos. 5,113,585 and 5,454,164. Although these types of caps with lubricating strips and lubricating substances are very lubricious when wet, they are not very lubricous when dry. The surface containing the lubricating substances may become rough and pitted over time as the lubricating strip or shaving composite wear away. The user often has to replace the cartridge, not because the blade is dull, but because the cap (lubricating strip) no longer provides a lubricous or comfortable shave. The wearing away of the lubricating substances in certain razors is even more problematic because the cap and lubricating strip are used achieve the shaving angle of the blade. As the lubricating substances wear, the shaving angle may change, resulting in a more aggressive and uncomfortable shave. In certain areas of the world shaving razors are not used and stored in a controlled environments, and are thus more susceptible to heat and humidity. The lubricating substances may experience even greater wear and dry out faster in hot environments. The shaving aid composite of the cap may release lubricious substances unnecessarily when the shaving cartridge is not being used, especially in areas of the world with increased humidity. The cap 14 may provide a cost effective alternative to caps that include a lubricating strip joined to the cap or caps having a shaving aid composite that delivers a lubricious substance. The cap 14 may provide for a consistent shaving angle and allow for adequate lubricity and comfort.

The housing 12 and the cap 14 may be molded from polymers such as high impact polystyrene (HIPS), but other semi-rigid polymers such as polypropylene (PP) and acrylonitrile butadiene styrene (ABS) may also be used. Generally rigid materials, such as polystyrene based plastics, maintain the cap 14 and the housing 12 geometry during shaving, thus further reducing drag and friction against the surface of the skin. Flexible materials, such as elastomers, may allow the ribs 16 to fold over, increasing the surface contact area against the skin and thus increasing drag against the surface of the skin. Additives such as silicone, PTFE or PPO may be added to the polymer to improve surface lubricity of the cap 14 against the skin surface during shaving. In certain embodiments, the cap 14 may be integral with the housing 12. The material the cap 14 is composed of may not degrade or wear over time so the cap 14 maintains its geometry independent of the blade 30 becoming dull. The user may be able to get more shaves from the same cartridge 10 because cartridge 10 would need to be replaced only when the blade 30 becomes too dull, which may vary greatly depending on the user. The cartridge 10 would not need to be prematurely replaced because of discomfort that is the result of a worn cap 14.

Many concepts have been developed that claim to help increase blade life (total number shaves before the blade cartridge needs to be replaced) by maintaining the blade edge. Such concepts may include cryogenically freezing blades, coating or submerging blades in various oils or rubbing alcohol. Others concepts may include razor-storage devices with a small fan and/or heater for drying the blades of a cartridge after use. Users of such methods and devices are not able to achieve the full benefit of a cartridge that maintains shaving comfort longer because the cap would still be susceptible to wear. The blades of the cartridge may maintain their sharpness, but the user may still experience an uncomfortable shave because of the wearing away of the lubricating substances on the cap. The lubricious substances on the cap or a lubricating strip may be completely used up before the blade becomes dull because the cartridges were not designed to have an extended blade life. Such methods and devices may even increase the wear of the lubricious substances on the cap or have other detrimental effects on the lubricity of the cap. Consumers that use shaving cartridges to shave dry, such as razors used to prep patients for surgery, never realize the increased comfort of the lubricating materials because not water is applied to the cartridge during shaving. The dry cap would result in increased discomfort because the dry rough surface of the cap would have a increase friction and would drag across the skin.

A cap having a generally uniform surface creates a significant amount of friction and drag as the cartridge is passed along the surface of the skin. This is typically why caps include a shaving aid composite to deliver a lubricious substance to the user's skin. The cap 14 may have a plurality of ribs 16 that extend generally traverse to the blade 30. The ribs 16 may support the skin along a substantial length of the blade 30 for a more comfortable shave. The ribs 16 also reduce the overall surface contact area with the skin. The surface contact area with the skin may be the total surface area of the top surface of all of the ribs 16 that come into contact with the surface of the skin during shaving. The ribs 16 may have either a generally flat top surface or a generally curved top surface. The top surface of the ribs 16 may reduce the contact area of the cap 14 by about 30%, 40%, or 50% to about 60%, 70% or 80%. For example, if the cap 14 had a generally uniform surface with no ribs the skin surface contact area would be about 140 mm². However, the skin surface contact area of the cap 14, as shown with ribs 16, may be about 30 mm² (a 79% decrease in skin surface contact act area). In certain embodiments, the skin surface contact area of the cap 14 may be about 25 mm², 35 mm², 45 mm², or 55 mm² to about 75 mm², 85 mm², or 95 mm². The ribs 16 may be generally rectangular or trapezoid in cross-section with an aspect ratio of about less than 2:1, such that a base of the rib 16 is generally the same size as a top surface of the rib 16. For example, the ribs 16 may have an aspect ratio of about 1:1, 1:1.3, or 1:1.5 to about 1:1.6, 1:1.7, or 1:1.9. A greater aspect ratio may cause the ribs 16 to scrape the user's skin resulting in an uncomfortable experience. A top surface of the ribs 16 may be generally flat with a smooth finish to reduce drag against the surface of the skin. The ribs 16 may be generally equidistantly spaced and may extend generally the entire length of the cap 14. The ribs 16 may have pitch of about 0.25 mm, 0.50 mm, or 0.70 mm to about 1.0 mm, 1.25 mm, or 1.5 mm.

An intermediate portion 28 may be located between the blade 30 and the cap 14. The intermediate portion 28 may be part of the cap 14, the blade 30 or the housing 12. The plurality of ribs 16 may extend from the intermediate portion 28 to a rear end wall 32 of the housing 12. Adjacent ribs 16 may define open channels 36 that extend from the intermediate portion 28 to the rear end wall 32. The open channels may have a depth of about 0.05 mm, 0.1 mm, or 0.2 mm to about 0.25 mm, 0.4 mm, or 0.6 mm. In certain embodiments, the ribs 16 and the open channels 36 may extend at least past the rear end wall 32. The rear end wall 32 may be curved to provide for a smooth transition to a back wall (not shown) of the housing 12. The ribs 16 and the channels 36 may also be curved as they transition from the rear end wall 32 to the back wall (not shown). The open channels 36 may provide a path for removing shave prep from the surface of the skin during shaving. The removal of shave prep tends to be an indicator for most users that a certain area of skin has been adequately shaved. If shave prep is left behind a consumer may unnecessarily shave the area again, thus increasing the probability of nicks and cuts. The intermediate portion 28 may provide an unobstructed path for the passage of shave prep from the blade 30 to the open channels 36. The open channels 36 may be generally concave, which may improve the rinsing of the open channels 36. Channels with sharp corners or ribs with straight edges may be difficult to rinse, thus leaving behind trapped shaving aid and shaving debris.

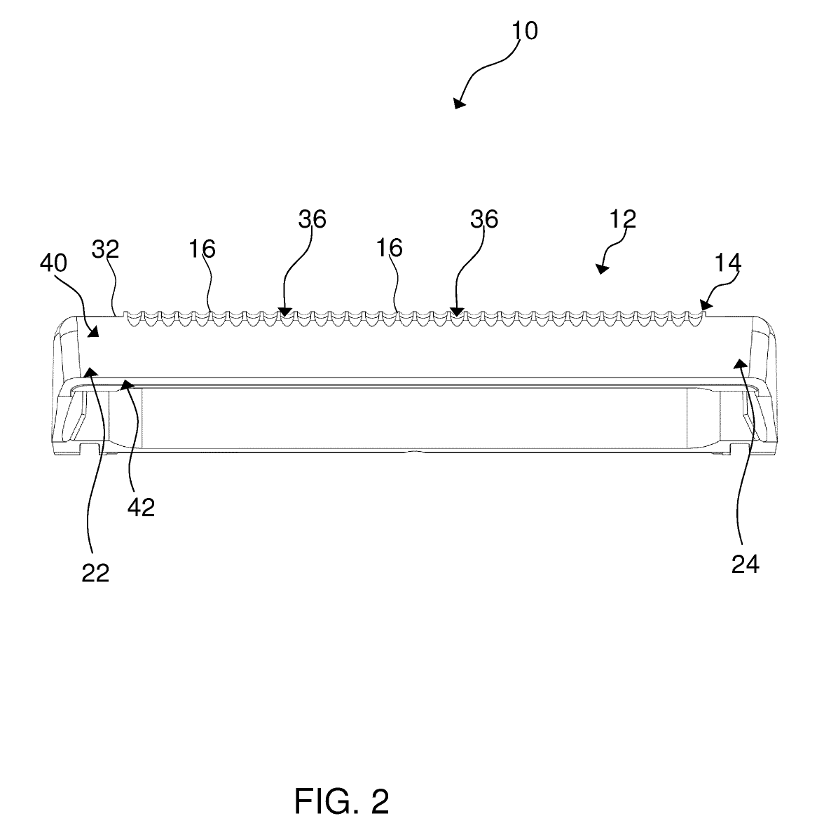

Referring to FIG. 2, a back wall 40 of the housing 12 is shown. The back wall 40 may begin at the rear end wall 32 and extend to a bottom surface 42 of the housing 12. The back wall 40 may extend along an entire length of the housing 12. In certain embodiments, the ribs 16 and the channels 36 may continue generally unobstructed from the rear end wall 32, to the back wall 40, and generally along at least a portion of the back wall 40, which may aid in removing excess shave prep from the surface of the skin. Shave prep may be forced along the channels 36 of the rear portion 18 (see FIG. 1) during shaving and flow out to the channels 36 of the back wall 40 away from the surface of the skin. The channels 36 may trap the shave prep rather than either gliding over the shave prep or pushing the shave prep to a different area of the face. The ribs 16 and channels 36 may be positioned about 70%, 75%, or 80% to about 85%, 90% or 100% of the length of the back wall 44. The ribs 16 and channels 36 may extend about 5%, 10%, 15% to about 20%, 25%, or 30% along the back wall toward the bottom surface 42. In certain embodiments, the ribs 16 and channels 36 may extend all the way to the bottom surface 42.

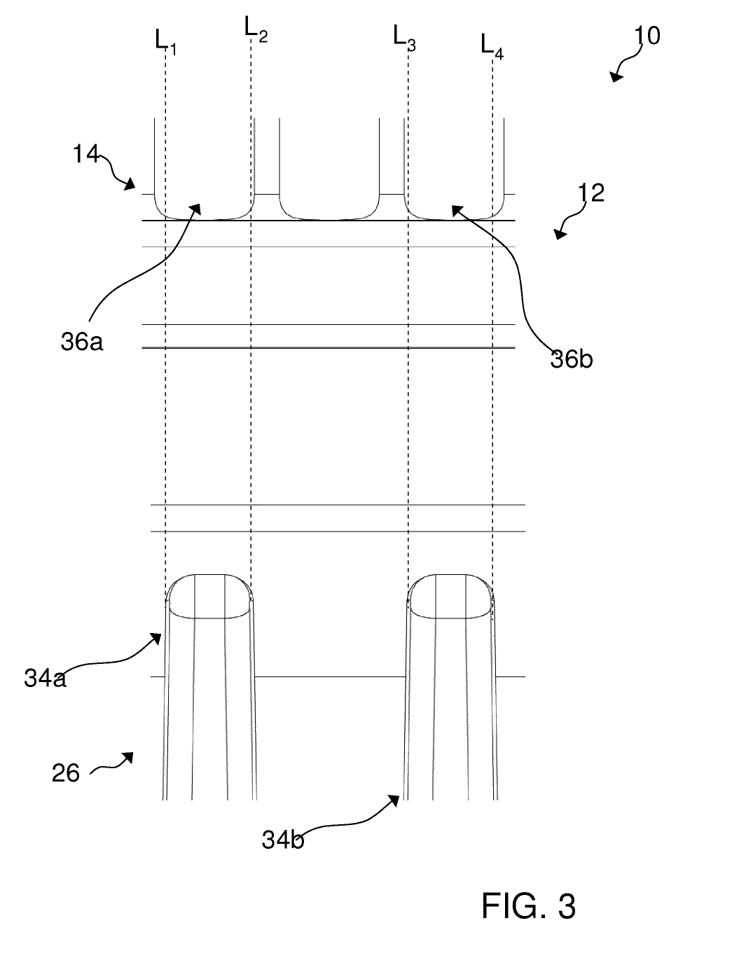

Referring to FIG. 3, a detailed top plan view of a portion of the cartridge 10 is shown. In certain embodiments, one or more of the projections of the guard may be generally aligned with one or more of the channels 36 of the cap 14. For example, projected lines L₁ and L₂ of the projection 34a of the guard 26 may overlap the channel 36a and lines L₃ and L₄ of projection 34b of the guard 26 may overlap the channel 36b. The ribs 16 and the projections 34 may aid in preventing travel of the cartridge in a direction not parallel to the ribs 16 of the cap 14 and projections 34 of the guard 26, which helps to avoid slicing cuts. A standard lubricating strip without any ribs may be more likely to facilitate travel of the cartridge in a direction not parallel to the shaving direction (generally perpendicular to the blades), especially if the cartridge has a non elastomeric guard that does not grip the skin well. Such a design would result in increased slicing cuts of the user's skin.

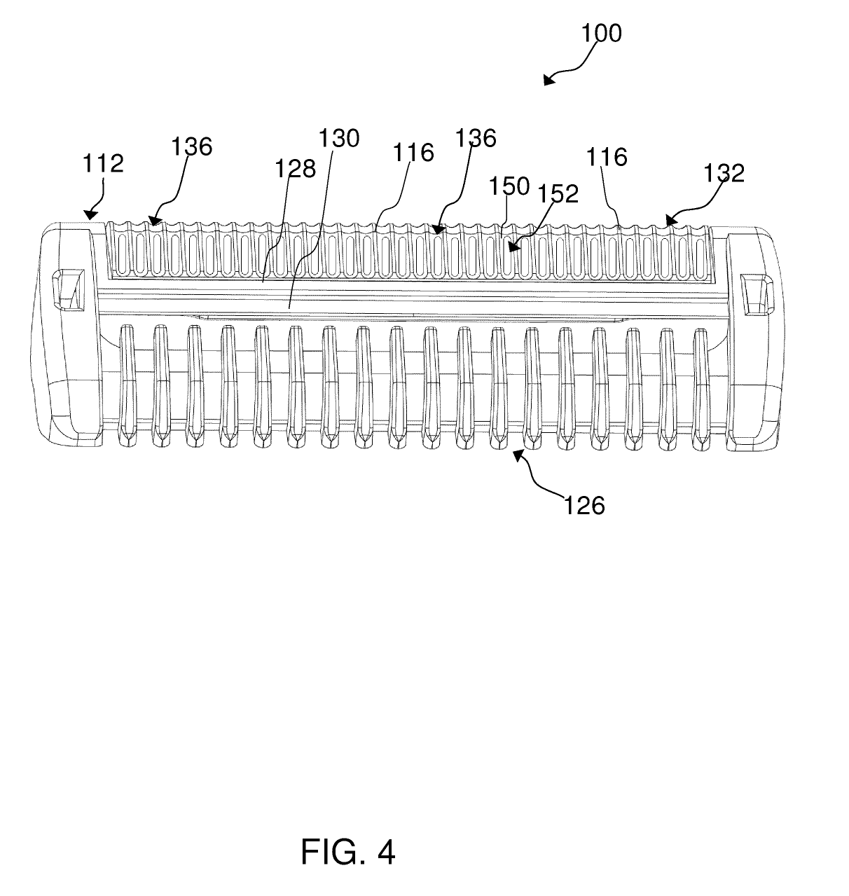

Referring to FIG. 4, another possible embodiment of the present disclosure is shown illustrating a shaving cartridge 100. The shaving cartridge 100 may include a housing 112, a guard 126, and a blade 130 similar to the shaving cartridge 10 shown in FIG. 1. The shaving cartridge 100 may be the same or similar as the shaving cartridge 10 described above with similar advantages, however the shaving cartridge 100 may have a modified cap 114.

The cap 114 may be integral with the housing 112 and may be molded from similar materials as described for the cap 14. The cap 114 may have a plurality of ribs 116 that extend generally traverse to a blade 130. The ribs 116 may support the skin along a substantial length of the blade 130 for a more comfortable shave. The ribs 116 also reduce the overall surface contact area with the skin, as described above. The ribs 116 may have either a generally flat top surface or a generally curved top surface. Adjacent ribs 116 may define open channels 136 that extend from an intermediate portion 128 adjacent to the blade 130 to at least past a rear end wall 132. In certain embodiments, the ribs 116 and the open channels 136 may extend from the blade 130 up to the rear end wall 132.

The open channels 136 may provide a path for removing shave prep from the surface of the skin during shaving. The removal of shave prep tends to be an indicator for most users that a certain area of skin has been adequately shaved. If shave prep is left behind a consumer may unnecessarily shave the area again, thus increasing the probability of nicks and cuts. The intermediate portion 128 may not obstruct the passage of shave prep from the blade 130 to the open channels 136. One or more of the open channels 136 may have a bottom surface 150 that defines an aperture 152 that extends through the housing 112. The aperture 152 may allow for additional shave prep to be removed from the surface of the skin.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving cartridge comprising:
a housing having a first lateral end portion, a second lateral end portion, a front portion and a rear portion, the rear portion having a rear end wall;
at least one blade mounted to the housing, the blade having a length extending from the first lateral end portion to the second lateral end portion;
a guard positioned at the front of the housing, and extending from the first lateral end portion to the second lateral end portion; and
a cap positioned at the rear portion of the housing and having a length extending from the first lateral end portion to the second lateral end portion, the cap having a plurality of ribs positioned from the first lateral end portion to the second lateral end portion, the plurality of ribs being generally transverse to the blade and defining a plurality of channels that extend from the rear portion of the housing to at least along a portion of the rear end wall.

2. The shaving cartridge of claim 1 wherein the guard has a plurality of projections extending generally transverse to the blade.

3. The shaving cartridge of claim 2 wherein at least one of the projections of the guard is generally aligned with at least one of the channels of the cap.

4. The shaving cartridge of claim 1 wherein the rear end wall has a generally curved surface.

5. The shaving cartridge of claim 1 wherein the plurality of ribs have a generally rectangular cross section with an aspect ratio less than 2:1.

6. The shaving cartridge of claim 5 wherein the cap extends from about 75% to about 100% of the length of the blade.

7. The shaving cartridge of claim 6 wherein the cap is integral with the housing.

8. The shaving cartridge of claim 6 wherein the channels are equidistantly spaced along the cap.

9. The shaving cartridge of claim 6 wherein at least one of the ribs has a generally flat top surface.

10. The shaving cartridge of claim 6 wherein at least one of the ribs has a generally curved top surface.

11. The shaving cartridge of claim 6 wherein the channels have a pitch of about 0.25 mm to about 1.5 mm.

12. The shaving cartridge of claim 11 wherein the channels have a depth of about 0.1 mm to about 0.6 mm.

13. The shaving cartridge of claim 1 further comprising an intermediate portion positioned between the blade and the cap and having a length extending from the first lateral end portion to the second lateral end portion.

14. The shaving cartridge of claim 1 wherein at least one of the channels has a bottom surface defining an aperture extending through the housing.

15. A shaving cartridge comprising:
a having a first lateral end portion, a second lateral end portion, a front portion and a rear portion, the rear portion having a back end wall;
at least one blade mounted to the housing, the blade having a length extending from the first lateral end portion to the second lateral end portion
a guard positioned at the front of the housing, and extending from the first lateral end portion to the second lateral end portion
a cap positioned at the rear portion of the housing and having a length extending from the first lateral end portion to the second lateral end portion, the cap having a plurality of ribs generally transverse to the blade which define a plurality of channels, wherein the channels have a bottom surface defining an aperture extending through the housing.

16. The shaving cartridge of claim 15 wherein the channels extend from the rear portion of the housing to the rear wall and along at least a portion of the rear wall.

17. The shaving cartridge of claim 16 wherein the guard has a plurality of projections extending generally transverse to the blade.

18. The shaving cartridge of claim 16 wherein at least one of the projections of the guard is generally aligned with at least one of the channels of the cap.

19. The shaving cartridge of claim 15 wherein the back end wall has a generally curved surface.

20. The shaving cartridge of claim 15 wherein the plurality of ribs extend an entire length of the cap and the cap the cap extends about 75% to about 100% the length of the blade.
